(19) United States
(12) Patent Application Publication
(10) Pub. No.: US 2026/0160450 A1
(43) Pub. Date: Jun. 11, 2026

(54) Close Structure Solar Concentrator Compressed Air Energy Storage System

(71) Applicant: Yonghua Wang, Klamath Falls, OR (US)

(72) Inventor: Yonghua Wang, Klamath Falls, OR (US)

(21) Appl. No.: 18/831,360

(22) Filed: Dec. 11, 2024

(51) Int. Cl. F24S 20/20; F24S 20/00; H02S 10/00

(52) U.S. Cl. CPC F24S 20/20; H02S 10/00; F24S 2020/17

(57) ABSTRACT

A combined Concentrating Solar Power (CSP) and compressed air energy storage system employs a close structure solar concentrator as a compressed air storage tank to both concentrate sunlight and store energy. The close structure solar concentrator compressed air energy storage system comprises a close structure solar concentrator, a hybrid photovoltaic and solar thermal receiver, a thermal energy storage system, a thermal power generation system, a air compressor, an air motor, a electric generator, a heat exchange 1, and a heat exchanger 2. The system cogenerates electricity and thermal energy, stores energy, and recycles the thermal energy generated during the air compressing process.

### TECHNICAL FIELD

The present disclosure relates generally to compressed air energy storage system, more specifically, to a compressed air energy storage system with close structure solar concentrators as compressed air storage tanks.

### BACKGROUND

As solar photovoltaic (PV) technology progress, the cost of PV panel dropped more than 90% in past 2 decades. The main challenge that impedes the wide-spread adoption solar technology and makes it the main stream of power supply is lack of reliable utility scale energy storage. Among the variety of existing energy storage technologies, compressed air energy storage appears to be the most desirable technology due to its physical mechanism, simple structure, low capital cost, high efficiency, fast ramping, low fuel consumption, and good long-term operation record. There are many highly successful plants in operation demonstrating its feasibility. However, most of the compressed air energy storage plants are constructed based on underground salt caverns which are very limited. Those compressed air energy storage plants based on aboveground pipes and vessels are too expensive due to the costly pipes and vessels. Hence, novel solutions for dramatically reducing the cost of aboveground compressed air energy storage system will vastly promote the wide-spread adoption of compressed air energy storage system.

U.S. Pat. No. 9,938,896 B2 granted to Sherbrooke Abdelfettah Bannari (Bannari) discloses a solution to reduce the cost of compressed air energy storage system. Bannari's system comprises a compressed air tank structured to store compressed air above 200 bars, a heat storage unit containing a heat transfer fluid and having a latent heat storage material, and a heat exchanger. In Bannari's disclosure, the pressure higher than 200 bars is used to reduce the cost of the entire system, while the pipes and vessels have not been changed essentially.

The objective of the present invention is to provide a compressed air energy storage system with close structure solar concentrators as compressed air storage tanks instead of conventional pipes and vessels, so that the close structure solar concentrators function both concentrating sunlight and storing compressed air. Therefore the present invention discloses a combined Concentrating Solar Power (CSP) system and energy storage system. The CSP system generates electric power and the electric power is stored into the solar concentrators through compressed air.

### SUMMARY

According to the present invention a close structure solar concentrator compressed air energy storage system is provided to concentrate sunlight and cogenerate electricity and thermal energy, as well as store the cogenerated energy into close structure solar concentrators through compressed air. Comprehended by the invention is a power generation and energy storage system comprising a close structure solar concentrator, a hybrid solar thermal and photovoltaic receiver, a thermal energy storage, a thermal power generation system, a air compressor, a air motor, a electric generator, a heat exchanger 1, and a heat exchanger 2, wherein the close structure solar concentrator is located on the top of the receiver to optically couple concentrated sunlight onto the receiver to cogenerate electric power and thermal energy; the receiver is electrically connected to the compressor through cabals to power the compressor directly and thermally connected to 1 the thermal energy storage system through pipes and pumps; the thermal energy storage is connected to the thermal power generation system through pipes and pumps to regenerate electric power through the stored thermal energy; the thermal power generation system is electrically connected to the air compressor through cabals to power the air compressor; the air compressor is connected to the close structure solar concentrator through pipes to store the compressed air; the close structure solar concentrator is connected to the air motor through pipes to power the air motor by using compressed air; the air motor is mechanically connected to the electric generator through shaft to generate electric power; the heat exchanger 1 is connected to the air compressor and the thermal energy storage system through pipes and pumps; and the heat exchanger 2 is connected to the thermal storage system and the air motor through pipes and pumps.

When in operation, the incident sunlight is concentrated by the close structure solar concentrator onto the receiver to cogenerate electricity and thermal energy in an ultra-high total conversion efficiency, then the cogenerated electricity is stored into the close structure solar concentrator through compressing air, and the cogenerated thermal energy is converted back to electricity through the thermal power generation system and get stored into the close structure solar concentrator through compressing air. The heat generated in the air compressing process is recycled through the heat exchanger 1 and heat exchanger 2. It can be observed that the core component close structure solar concentrator plays a double role in converting solar radiation in ultra-high total conversion efficiency and efficiently store cogenerated energy. Therefore, system of the present invention has a great potential to dramatically reduce the total cost of the solar energy system.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a schematic diagram showing a close structure solar concentrator compressed air energy storage system with a non-imaging close structure solar concentrator as compressed air storage tank and a corresponding CSP system.

FIG. 2 is a schematic diagram showing a close structure solar concentrator compressed air energy storage system with an imaging close structure solar concentrator as compressed air storage tank and a corresponding CSP system.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

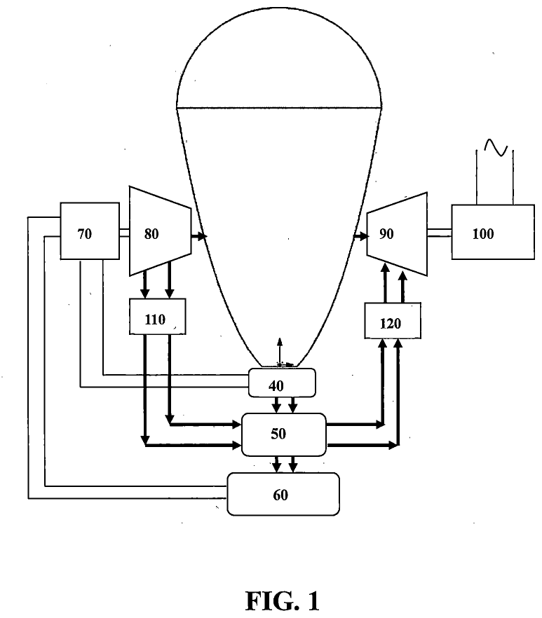

Referring to FIG. 1, the first embodiment of the close structure solar concentrator compressed air energy storage system is configured with a non-imaging solar concentrator 30, a hybrid photovoltaic and thermal receiver 40, a thermal energy storage system 50, a thermal power generation system 60, a electric motor 70, a compressor 80, an air motor 90, a electric generator 100, a heat exchanger 1 110, and a heat exchanger 2 120, wherein, the non-imaging solar concentrator 30 couples concentrated sunlight onto the hybrid photovoltaic and thermal receiver 40; the hybrid photovoltaic and thermal receiver 40 cogenerate electricity and thermal energy and supplies the electricity to the electric motor 70 and transfers the cogenerated thermal energy to the thermal energy storage system 50; the thermal power generation system 60 takes the stored thermal energy from the thermal energy storage 50 to generate electricity and supply the electricity to the electric motor 70; the electric motor drives the compressor 80 to compress air and feed the compressed air into the non-imaging close structure solar concentrator 30; the stored compressed air is released to drive the air motor 90 and generate electricity through the electric generator 100 to supply power to outside electric loads; the heat exchanger 1 110 transfers the heat generated in air compressing process to the thermal energy storage system 50; the heat exchanger 120 extracts the stored heat in the thermal energy storage system to heat the compressed air in air motor 70.

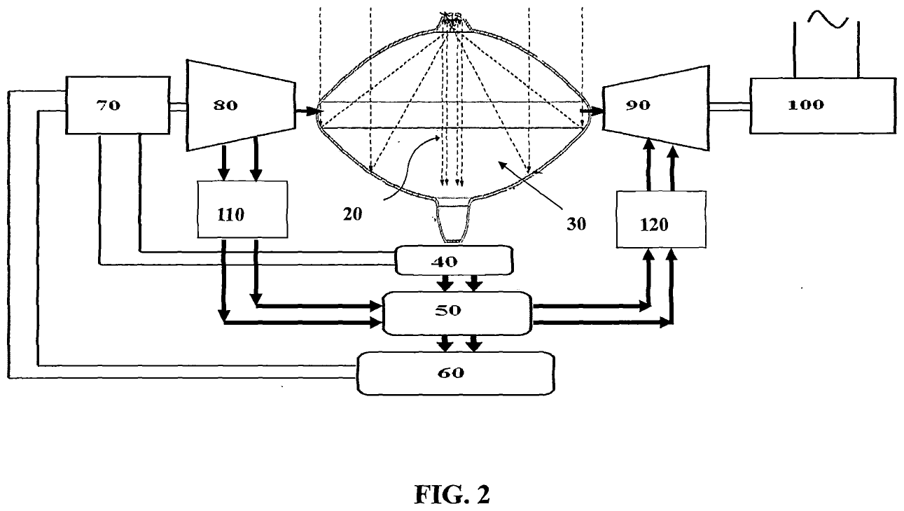

Referring to FIG. 2, the second embodiment of the close structure solar concentrator compressed air energy storage system is configured with an imaging solar concentrator 30, where incident sunlight 10 shows the imaging concentrating optics, a hybrid photovoltaic and thermal receiver 40, a thermal energy storage system 50, a thermal power generation system 60, a electric motor 70, a compressor 80, an air motor 90, a electric generator 100, a heat exchanger 1 110, and a heat exchanger 2 120, wherein, the imaging solar concentrator 30 couples concentrated sunlight onto the hybrid photovoltaic and thermal receiver 40; the hybrid photovoltaic and thermal receiver 40 cogenerate electricity and thermal energy and supplies the electricity to the electric motor 70 and transfers the cogenerated thermal energy to the thermal energy storage system 50; the thermal power generation system 60 takes the stored thermal energy from the thermal energy storage 50 to generate electricity and supply the electricity to the electric motor 70; the electric motor drives the compressor 80 to compress air and feed the compressed air into the imaging close structure solar concentrator 30; the stored compressed air is released to drive the air motor 90 and generate electricity through the electric generator 100 to supply power to outside electric loads; the heat exchanger 1 110 transfers the heat generated in air compressing process to the thermal energy storage system 50; the heat exchanger 120 extracts the stored heat in the thermal energy storage system to heat the compressed air in air motor 70.

From the description above, a number of advantages of the close structure solar concentrator compressed air energy storage system become evident. The close structure solar concentrator functions as both solar concentrator for the CSP system and compressed air storage tank for the compressed air energy storage system to dramatically reduce the total cost of the combined solar power generation and energy storage system. The close structure solar concentrator compressed air energy storage system stores the electricity directly cogenerated by the concentrating hybrid photovoltaic and solar thermal system and the regenerated electricity from the cogenerated thermal energy by the concentrating hybrid photovoltaic and solar thermal system. Therefore, the system of the present invention realizes ultra-high conversion efficiency and self energy storage at low cost.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. A close structure solar concentrator compressed air energy storage system, comprising a close structure solar concentrator, a hybrid photovoltaic and solar thermal receiver, a thermal energy storage system, a thermal power generation system, a air compressor, an air motor, a electric generator, a heat exchange 1, and a heat exchanger 2;
wherein, the close structure solar concentrator is located on the top of the hybrid photovoltaic and solar thermal receiver to optically couple concentrated sunlight onto the hybrid photovoltaic and solar thermal receiver to cogenerate electric power and thermal energy; the hybrid photovoltaic and solar thermal receiver is electrically connected to the compressor through cabals to power the compressor directly and thermally connected to the thermal energy storage system through pipes and pumps; the thermal energy storage system is connected to the thermal power generation system through pipes and pumps to regenerate electric power from the stored thermal energy; the thermal power generation system is electrically connected to the air compressor through cabals to power the air compressor; the air compressor is connected to the close structure solar concentrator through pipes to store the compressed air; the close structure solar concentrator is connected to the air motor through pipes to power the air motor by using compressed air; the air motor is mechanically connected to the electric generator through shaft to generate electric power; the heat exchanger 1 is connected to the air compressor and the thermal energy storage system through pipes and pumps; and the heat exchanger 2 is connected to the thermal storage system and the air motor through pipes and pumps; when in operation, the close structure solar concentrator concentrates sunlight and couples the concentrated sunlight onto the hybrid photovoltaic and thermal receiver to cogenerate electricity and thermal energy; the cogenerated electricity is directly supplied to the air compressor to compress air and feed it into the close structure solar concentrator; the thermal energy generated during the air compressing process is transferred into the thermal energy storage system through the heat exchanger 1; the cogenerated thermal energy by the hybrid photovoltaic and thermal receiver is transferred into the thermal energy storage system; the stored thermal energy is extracted to regenerate electricity through the thermal power generation system to power the air compressor; the thermal energy stored in the thermal storage system is extracted through the heat exchanger 2 to heat the compressed air when it is released to the air motor; the air motor drive the electric generator to regenerate electricity.

2. The close structure solar concentrator compressed air energy storage system of claim 1, wherein the close structure solar concentrator is a non-imaging close structure solar concentrator in the first embodiment.

3. The close structure solar concentrator compressed air energy storage system of claim 1, wherein the close structure solar concentrator is a imaging close structure solar concentrator in the second embodiment.
